(19) United States
(12) Patent Application Publication
(10) Pub. No.: US 2014/0375444 A1
(43) Pub. Date: Dec. 25, 2014

(54) BUS STOP SIGNAL

(71) Applicant: Continental Automotive Systems, Inc., Auburn Hills, MI (US)

(72) Inventors: Saul Alejandro Madrigal Medina, Tlaquepaque (MX); Jonathan Efren Limon Sepulveda, Guadalajara (MX)

(21) Appl. No.: 13/923,793

(22) Filed: Jun. 21, 2013

(51) Int. Cl. B60Q 1/50

(52) U.S. Cl. CPC B60Q 1/50
USPC 340/433

(57) ABSTRACT

A bus stop signal for alerting the driver of a bus and surrounding vehicles that one or more of the passengers has requested that the bus stop at the next bus stop location. The bus stop signal includes a stop indicator signal, and a device in electrical communication with the stop indicator signal. The device includes a housing, and a switch at least partially mounted within the housing. A handle bar is located in the passenger area of the bus, and the device is mounted to the handle bar such that the switch is pressed by at least one passenger in the vehicle, to activate the stop indicator signal. The bus also includes a rear panel, and the stop indicator signal is mounted to the rear panel. Multiple stop indicator signals may be used on other panels of the bus to provide an indication that a stop has been requested.

### FIELD OF THE INVENTION

The invention relates generally to a signal used by a passenger on a bus to provide an alert to other drivers that a request has been made for the bus to stop at an upcoming bus stop location.

### BACKGROUND OF THE INVENTION

Passenger buses used to provide public transportation have various types of signals, such as flashing lights, sounds, and the like, to provide an indication that the bus is stopping. Buses used for public transportation also typically travel the same route, and stop and the same bus stop locations on the route while dropping off and picking up passengers. When the bus is approaching one of the bus stop locations, one or more of the signals are activated by the bus driver, alerting other drivers that the bus is going to stop, either to allow additional passengers to enter the bus, or to allow existing passengers to exit the bus. It is common that bus drivers leave the hazard lights on, which often misleads surrounding drivers because hazard lights are also used during emergencies, in addition to providing an alert that the bus is going to stop to pick up or drop off passengers.

When the bus is travelling along the route, the bus driver may not stop at each bus stop location if there are no passengers to be picked up. However, passenger buses also include devices used by the different passengers to indicate that even if there is no one waiting at a particular bus stop location, a passenger may activate the signal to indicate to the bus driver that a stop is requested, and the passenger desires to depart the bus at the next stop.

However, even after the passenger has activated the signal to request a stop, drivers in other vehicles are not alerted when this occurs. The drivers in nearby vehicles are only provided with an indication that the bus is going to stop at the next bus stop location when one of the signals is activated, which may only be activated by the bus driver.

Accordingly, there exists a need for a way to provide an indication to nearby vehicles that one or more of the passengers have requested that the bus stop at the next bus stop location independently of the control of the bus driver, well in advance of an upcoming bus stop location.

### SUMMARY OF THE INVENTION

The present invention is a bus stop signal for alerting the driver of a vehicle, such as a bus, and drivers of surrounding vehicles that one or more of the passengers has requested that the bus stop at the next bus stop location. The bus stop signal includes a stop indicator signal, and a device in electrical communication with the stop indicator signal. The device includes a housing, and a switch at least partially mounted within the housing. A handle bar is located in the passenger area of the bus, and the device is mounted to the handle bar. The switch is pressed by at least one passenger in the bus to activate the stop indicator signal. One or more of the passengers have control over the actuation of the stop indicator signal. The bus also includes a rear panel, and the stop indicator signal is mounted to the rear panel to alert drivers of vehicles behind the bus that a stop has been requested.

In an embodiment, the stop indicator signal further includes a plurality of stop indicator signals mounted to different areas of the vehicle, and the bus includes at least one side panel and a front panel. One or more of the plurality of stop indicator signals is mounted to the side panel, and one or more of the plurality of stop indicator signals is mounted to the front panel.

When a passenger activates the stop indicator signal from inside the bus, the stop indicator signal located on the rear panel of the bus is activated to make the drivers of surrounding vehicles aware the bus is going to stop at the next bus stop location. One of the advantages of the present invention is that the stop indicator signal increases the awareness of the drivers of vehicles around the bus that a stop has been requested, and that the bus is going to stop at the next bus stop location.

The bus stop indicator signal of the present invention may be incorporated into vehicles during production assembly, or the bus stop indicator signal may be installed as an aftermarket component.

In an embodiment, the bus stop signal is a light which is illuminated by the switch. This type of signal is easily understood, and may be adapted for use in different countries.

In an embodiment, the stop indicator signal is in wireless communication with the device, through the use of wireless communication such as a control area network (CAN), and may use standard communication protocols, or other communication protocols, depending upon the application. However, in other embodiments, the stop indicator signal may be in wired communication with the device.

In an alternate embodiment, the stop indicator signal is a group of letters which are selectively illuminated when the device is activated by one or more of the passengers inside the bus. The letters are mounted on the rear panel, or other panels, such as the side panels or front panel. When the letters are illuminated, drivers of surrounding vehicles are alerted that a stop has been requested by one of more of the passengers.

In other alternate embodiments, the stop indicator signal may not be limited to the use of a bus, such as a school bus or passenger bus. The stop indicator signal may also be used for other vehicles which transport passengers, such as rail cars, or the like.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a bus having a bus stop indicator signal, according to embodiments of the present invention;

FIG. 2A is a first rear view of a bus having a bus stop indicator signal, where the signal is not illuminated, according to embodiments of the present invention;

FIG. 2B is a second rear view of a bus having a bus stop indicator signal, where the signal is illuminated, according to embodiments of the present invention; and

FIG. 3 is a perspective view of a device used to actuate a stop indicator signal, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

A vehicle having an embodiment of a bus stop signal according to embodiments of the present invention is shown in the Figures generally at 10. In this embodiment, the vehicle 10 is a bus 10, which includes various lights, and signals which perform various functions. The bus 10 includes headlights 12, taillights 14, turn signals 16, and upper lights 18 which function as brake lights or hazard lights. The present invention is not limited to the different signals included as part of the bus 10, and may include additional lights and signals.

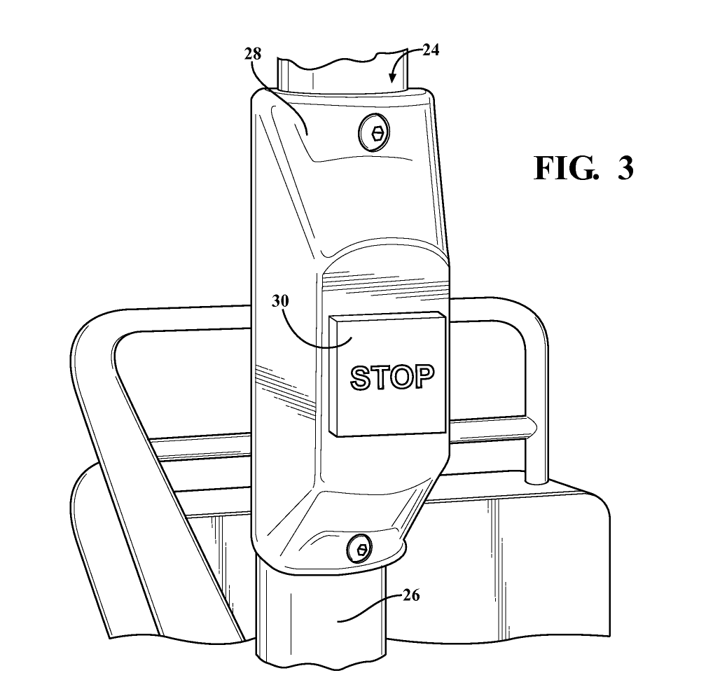

Also located on the rear panel 20 of the bus 10 is a signal, which in this embodiment is a stop indicator signal, shown generally at 22, which is activated by a passenger on the bus 10. The signal 22 is activated by an actuator device, shown generally at 24 in FIG. 3, which is mounted to a handle bar 26.

The device 24 includes a housing 28 and a switch 30, which in this embodiment, the switch 30 is in the form of a button having the word “STOP.” The device 24 is in some type of electrical communication with the signal 22, which in this embodiment is a wireless communication through the use of a control area network (CAN), and may use standard communication protocols, or other communication protocols, depending upon the application. In alternate embodiment, the signal 22 may also include, but is not limited to, a direct wire connection between the signal 22 and the device 24.

During the operation of the bus 10, when a passenger desires to exit the bus 10 at the next stop, the passenger presses the switch 30. The switch 30 may be pressed by any passenger on the bus 10. Pressing of the switch 30 alerts the driver of the bus 10 that a passenger desires to exit the bus 10 at the next stop. However, pressing the switch 30 also activates the signal 22. In this embodiment, the signal 22 is a light mounted on the rear panel 20 of the bus 10, and when the switch 30 is pressed, the signal 22 is illuminated, providing an alert to drivers in surrounding vehicles that the bus 10 is going to stop at the next bus stop location to allow at least the passenger who requested the stop to exit the bus 10. Any other passengers to also desire to exit the bus 10 may also exit at the bus stop location as well.

One of the advantages of the bus stop indicator signal 22 is that the signal 22 may be incorporated into vehicles, such as the bus 10 during production assembly, or the bus stop indicator signal 22 may be installed as an aftermarket component.

Another advantage of the stop indicator signal 22 is that the signal 22 is a light which is illuminated by the switch. This type of signal 22 is easily understood, and may be adapted for use in different countries.

While it is shown in FIG. 3 that the switch 30 is mounted to a handle bar 26, in other embodiments there is a plurality of switches 30 mounted to a plurality of handle bars throughout the bus 10 which may be activated by other passengers. The plurality of switches 30 mounted on the plurality of handle bars may be activated by any of the passengers to provide an indication to the driver of the bus 10 that a stop has been requested. One or more of the switches 30 may be pressed by one or more of the passengers because the bus 10 is a large vehicle, and not all of the passengers may be aware that one of the switches 30 has been pressed. Furthermore, the plurality of switches 30 may be mounted on the plurality of handlebars in different configurations. The plurality of handlebars may also be configured differently from one bus 10 to the next, and therefore the switches 30 may be arranged on the handlebars which best suits each particular bus 10.

Also, when any of the plurality of switches 30 is activated, the signal 22 is also illuminated as well, providing an indication to the drivers of other vehicles that the bus 10 is going to stop at the next bus stop location to allow the passengers to exit the bus 10. During the operation of the bus 10, one or more of the plurality of switches 30 may be activated, and the signal 22 is only activated once to provide an indication to drivers of other vehicles that at least one passenger has requested that the bus 10 stop at the next bus stop location to allow at least one of the passengers to exit the bus 10.

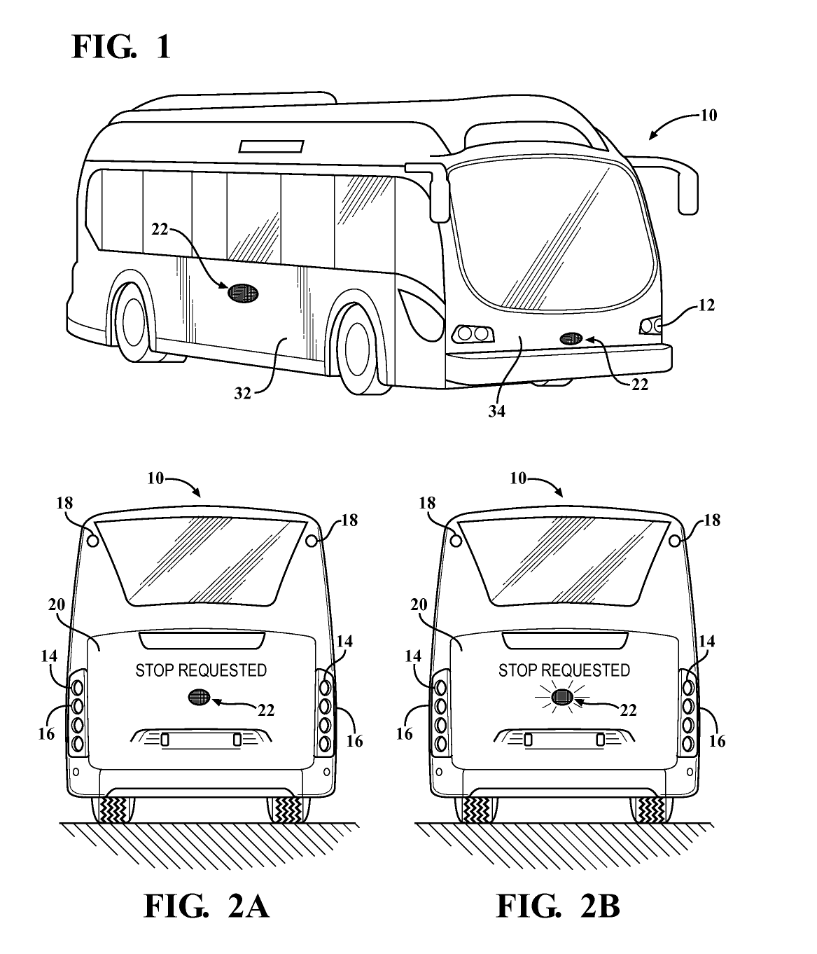

In alternate embodiments, additional signals 22 may be incorporated into the side panels 32 and front panel 34 to provide an indication to drivers of vehicles located on the sides and in the front of the bus 10 that a stop has been requested. The placement and location of the signal 22 on the bus 10 is also not limited to the rear panel 20, side panels 32, and front panel 34. The signal 22 may also be incorporated into other areas of each of the panels 20,32,34 shown in FIGS. 1-2B. Additionally, there may also be included multiple signals 22 on one or more of the panels 20,32,34 to provide further indication to drivers of other vehicles that a stop has been requested by one of the passengers on the bus 10.

In other alternate embodiments, the stop indicator signal 22 is a group of letters which are selectively illuminated when the device 24 is activated by one or more of the passengers inside the bus 10. The letters are mounted on the rear panel 20, or other panels, such as the side panels 32 or front panel 34. When the letters are illuminated, drivers of surrounding vehicles are alerted that a stop has been requested by one of more of the passengers

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a stop signal, including:
a signal mounted on at least one outer panel of a vehicle; and
a device located inside the vehicle, operable by at least one passenger in the vehicle;
wherein the signal is activated by the at least one passenger activating the device.

2. The apparatus of claim 1, the device further comprising:
a housing; and
a switch connected to the housing, wherein the switch is pressed by the at least one passenger to activate the signal.

3. The apparatus of claim 2, further comprising a handle bar, wherein the switch is mounted to the handle bar.

4. The apparatus of claim 1, the signal further comprising a plurality of stop indicator signals mounted to different areas of the vehicle.

5. The apparatus of claim 4, the vehicle further comprising:
at least one side panel; and
wherein one or more of the plurality of stop indicator signals is mounted to the at least one side panel.

6. The apparatus of claim 4, the vehicle further comprising:
a front panel;
wherein one or more of the plurality of stop indicator signals is mounted to the front panel.

7. The apparatus of claim 1, wherein the vehicle is one selected from the group consisting of a school bus, a passenger bus, a rail car, a van, or the like.

8. A stop signal, comprising:
a stop indicator signal mounted on a rear panel of a vehicle; and
a device operable by at least one passenger in the vehicle; and
a handlebar located inside the vehicle, the device mounted to the handlebar;
wherein the stop indicator signal is activated by the device when a passenger desires to exit the vehicle.

9. The stop signal of claim 8, the device further comprising:
a housing mounted to the handlebar; and
a switch connected to the housing, wherein the switch is pressed by the at least one passenger to activate the signal.

10. The stop signal of claim 8, the stop indicator signal further comprising a plurality of stop indicator signals mounted to different areas of the vehicle.

11. The stop signal of claim 10, the vehicle further comprising:
at least one side panel; and
a front panel;
wherein one or more of the plurality of stop indicator signals is mounted to the at least one side panel, and one or more of the plurality of stop indicator signals is mounted to the front panel.

12. The stop signal of claim 8, wherein the vehicle is one selected from the group consisting of a school bus, a passenger bus, a rail car, a van, or the like.

13. A bus stop signal, comprising:
a stop indicator signal;
a device in electrical communication with the stop indicator signal;
a housing, the housing being part of the device;
a switch at least partially mounted within the housing, the switch being part of the device; and
a handle bar located in the passenger area of a bus, the device mounted to the handle bar;
wherein the switch is pressed by at least one passenger in the bus, to activate the stop indicator signal.

14. The bus stop signal of claim 13, the vehicle further comprising a rear panel, wherein the stop indicator signal is mounted to the rear panel.

15. The bus stop signal of claim 14, the stop indicator signal further comprising a plurality of stop indicator signals mounted to different areas of the vehicle.

16. The bus stop signal of claim 15, the vehicle further comprising:
at least one side panel; and
a front panel;
wherein one or more of the plurality of stop indicator signals is mounted to the at least one side panel, and one or more of the plurality of stop indicator signals is mounted to the front panel.
